(19) United States
(12) Patent Application Publication
(10) Pub. No.: US 2019/0373941 A1
(43) Pub. Date: Dec. 12, 2019

(54) MANUFACTURING METHOD AND MANUFACTURING DEVICE FOR TRACE ELEMENT SUPPLEMENT GRANULES

(71) Applicant: XINGJIA BIO-ENGINEERING CO., LTD., Changsha, Hunan (CN)

(72) Inventors: Yiqiang HUANG, Changsha (CN); Jianjun TAO, Changsha (CN); Yajun YAO, Changsha (CN); Min DENG, Changsha (CN); Hongxing PENG, Changsha (CN); Feihui XIA, Changsha (CN); Yawei ZHANG, Changsha (CN)

(73) Assignee: XINGJIA BIO-ENGINEERING CO., LTD., Changsha, Hunan (CN)

(21) Appl. No.: 16/489,113

(22) PCT Filed: Mar. 5, 2018
(86) PCT No.: PCT/CN2018/078023

§ 371 Date: Aug. 27, 2019

(30) Foreign Application Priority Data
Jan. 5, 2018 (CN) 201810012202.6

(51) Int. Cl. A23P 10/22; B02C 23/14; B02C 23/12; B02C 23/02; B02C 21/00; A23L 33/165; A23K 20/20; A23K 40/10

(52) U.S. Cl. CPC A23P 10/22; B02C 23/14; B02C 23/12; B02C 23/02; A23V 2002/00; A23L 33/165; A23K 20/30; A23K 40/10; B02C 21/00

(57) ABSTRACT

A manufacturing method and manufacturing device for micronutrient supplement granules involve sequentially performing physically extruding, grinding and sieving of trace elements to obtain micronutrient supplement granules having a granule size of 35-380 μm and a granule strength greater than 10 N with a tablet press, a first grinding and granulating machine and a sieving unit including primary and secondary sieving machines. A discharge end of the tablet press is connected to a feed end of the first grinding and granulating machine, of which a discharge end is connected to a feed end of the sieving unit. Feed and discharge ends of the primary sieving machine are respectively connected to discharge end of the first grinding and granulating machine and feed end of the secondary sieving machine. The primary and secondary sieving machines have sieving meshes respectively with square and circular mesh holes.

### TECHNICAL FIELD

The present disclosure relates to the technical field of micronutrients, particularly to a preparation method of micronutrient supplement granules and an apparatus used for the preparation method.

### BACKGROUND

Micronutrient supplements, namely minerals and vitamins, are trace nutrients needed by human and animals, and have effects on strengthening survival abilities, growth, health and/or fecundity of human and other animals. The micronutrient supplements, such as basic salts, hydroxy-methionine chelates, threonine chelates and the like, are usually powdery. When the powdery micronutrient supplements are directly added in various foods or feeds, other nutrients in the foods or feeds may be destroyed. Furthermore, direct addition of the powdery micronutrient supplements produces dust, which harms workers and environments. Therefore, it is necessary to prepare the powdery micronutrient supplements into granules with a certain diameter and strength.

According to the existing methods/devices for preparation of micronutrient supplement granules, a powdery product is usually dissolved, then a binder is added therein, and the granules are prepared by spray drying. For example, the Chinese patent No. CN201280051529.5 introduces a method for preparing granules, in which micronutrient supplements and a digestible binder are agglomerated, and then spray dried to form the granules. The disadvantages of such device include the complexity of the production process due to the addition of a binder, the high cost of spray drying, the low content due to the addition of a carrier, and the low strength of granules that leads to friable granules.

### SUMMARY

The technical problem to be solved by the present disclosure is to overcome the defects and disadvantages mentioned in the above background of the disclosure, so as to provide a preparation method of micronutrient supplement granules with a low cost and a high granule strength, and provide an apparatus which is used to prepare micronutrient supplement granules with high qualities in a high production efficiency.

In order to solve the above technical problem, the technical solutions presented by the present disclosure are as follows

There is provided in the present disclosure a preparation method of micronutrient supplement granules, in which a micronutrient is physically pressed, grinded and screened in sequence to obtain micronutrient supplement granules with a granule diameter ranging from 35 μm to 380 μm and a granule strength of greater than 10 N.

In the preparation method, preferably, the micronutrient comprises a basic salt, a hydroxy-methionine chelate or a threonine chelate.

More preferably, the basic salt comprises one or more of basic zinc chloride, basic zinc sulfate, basic cupric chloride, basic cupric sulfate, copper(II) carbonate hydroxide, manganese hydroxy chloride and basic manganese sulfate. The hydroxy-methionine chelate comprises one or more of hydroxy methionine copper, hydroxy methionine ferrous, hydroxy methionine zinc and hydroxy methionine manganese. The mole ratio of the hydroxy-methionine to the metal ion in the hydroxy-methionine chelate is 1:1 or 2:1. The threonine chelate comprises one or more of threonine copper, ferrous threonine, threonine zinc and threonine manganese. The mole ratio of the threonine and the metal ion in the threonine chelate is 1:1 or 2:1.

In the preparation method, preferably, the pressure used during the pressing operation is controlled in a range of 1 MPa to 25 MPa, and a conveying speed of a pressing feeding screw is controlled in a range of 20 r/min to 200 r/min. The screening operation has two stages. A screen used in a primary screening stage is square-mesh screen having a square-mesh size ranging from 8 mm×8 mm to 3 mm×3 mm. A screen used in a secondary screening stage is a round-mesh screen having a round mesh diameter ranging from 0.8 mm to 2.1 mm.

The preparation method of the present disclosure sequentially comprises physically pressing, grinding and screening a micronutrient to obtain granules with a certain granule diameter. Compared with the conventional wet preparation method which needs addition of a binder and adopts spray drying, the preparation method of the present disclosure does not need any binder added into the micronutrient, which reduces the production cost. Moreover, when granulating according to the preparation method of the present disclosure, it is not necessary to form slurry which is required in the conventional method by stirring and dissolving the micronutrient and the binder, and thus drying is unnecessary, such that the production efficiency is greatly improved. Furthermore, since no binder is added in the micronutrient, the product prepared with the method of the present disclosure has a higher purity. Screening fractions are more complete because of the two-stage screening, which results in more than 80% of a one-time granulation rate. The granules having a diameter of 35 μm to 380 μm can be obtained with the method of the present disclosure, which reduces the damage of the micronutrient granules to other nutrients in the foods or feeds.

According to the general technical concept, according to another aspect of the present disclosure, there also provides an apparatus used in the preparation method. The apparatus comprises a tablet press, a first grinding and granulating machine, and a screening unit. A discharge end of the tablet press is connected with a feed end of the first grinding and granulating machine. A discharge end of the first grinding and granulating machine is connected to a feed end of the screening unit. The screening unit comprises a primary screening machine and a secondary screening machine. A feed end of the primary screening machine is connected to the discharge end of the first grinding and granulating machine, and a discharge end of the primary screening machine is connected to a feed end of the secondary screening machine.

Further improvements of the above technical solution are as follows.

Preferably, a screen of the primary screening machine is a square-mesh screen, and a screen of the secondary screening machine is a round-mesh screen. With the two-stage screening, the screening fractions are more complete, the granules with a certain diameter can be obtained, and the one-time granulation rate is high.

More preferably, the square-mesh size of the screen of the primary screening machine is ranging from 8 mm×8 mm to 3 mm×3 mm, and the round-mesh diameter of the screen of the secondary screening machine is ranging from 0.8 mm to 2.1 mm, in which the primary screening machine has two screens, in which the upper screen has the larger square-mesh size of 8 mm×8 mm and the lower screen has the smaller square-mesh size of 3 mm×3 mm. More preferably, the square-mesh size(s) of the screen(s) of the primary screening machine is ranging from 5 mm×5 mm to 4 mm×4 mm, and the round-mesh diameter of the screen of the secondary screening machine is ranging from 1.0 mm to 1.5 mm. The primary and the secondary screening machines adopting the above screen sizes achieve a better screening effect.

Preferably, the tablet press comprises a pressing feed bin. The lower part of the pressing feed bin is connected to a feed end of the pressing feeding screw, and a discharge end of the pressing feeding screw is connected to a pressing roller. The conveying speed of the pressing feeding screw is ranging from 20 r/min to 200 r/min. The pressure applied by the pressing roller is ranging from 1 MPa to 25 MPa. Within the ranges of the conveying speed of the pressing feeding screw and the pressure applied by the pressing roller, the micronutrient supplement granules with a sufficient strength can be obtained. More preferably, the conveying speed of the pressing feeding screw is ranging from 30 r/min to 60 r/min, and the pressure applied by the pressing roller is ranging from 4 MPa to 20 MPa.

Preferably, the feed end of the tablet press is connected to a pressing feeding device. The pressing feeding device includes a pressing vacuum feeder, which is connected to a feeding bucket through a pipeline.

More preferably, a screening vacuum feeder and a screening bin are arranged between the first grinding and granulating machine and the screening unit. A feed end of the screening vacuum feeder is connected with the discharge end of the first grinding and granulating machine through a pipeline. A discharge end of the screening vacuum feeder is connected to a feed end of the screening bin. A discharge end of the screening bin is connected with the feed end of the primary screening machine. The steps of pressing, grinding and screening are performed in a closed environment without dust escaping. There may be dust escaping only in the feeding step. Because the micronutrient fed into a hopper is generally powdery, which may generate dust that has an adverse effect on the health of workers. The present disclosure adopts the pressing vacuum feeder and the screening vacuum feeder in feeding steps, so that there is no dust escaping in the whole preparation process, which improves the working environment of production workshop.

More preferably, a coarse-granule outlet of the primary screening machine is connected with a feed end of a second grinding and granulating machine. A discharge end of the second grinding and granulating machine is connected to a feed end of the screening vacuum feeder through a pipeline. In this way, coarse granules obtained after screening with the primary screening machine are grinded by the second grinding and granulating machine and then fed back to the primary screening machine to be screened again, such that the internal circulation of materials is realized, which improves the production efficiency, and reduces the waste of materials.

More preferably, fine-powder outlets of the primary and the secondary screening machines are both connected to a fine powder buffer bucket. The fine powder buffer bucket is connected to the feed end of the pressing vacuum feeder through a pipeline. In this way, fine powder obtained after screening with the primary and the secondary screening machines is fed into the screening unit to be screened again, which further improves the production efficiency, and reduces the waste of materials.

More preferably, the primary and the secondary screening machines are flexibly connected through a cloth bag, the screening bin and the primary screening machine are flexibly connected through a cloth bag, the primary screening machine and the second grinding and granulating machine are flexibly connected through a cloth bag, and the fine-powder outlets of the primary and the secondary screening machines are flexibly connected with the fine powder buffer bucket through a cloth bag. The flexible connections are convenient for the primary and the secondary screening machines to perform vibratory screening.

Compared with the conventional techniques, the present disclosure has the following advantages.

(1) The preparation method of the present disclosure comprises physically pressing, grinding and screening a micronutrient in sequence to obtain the granules with a certain granule diameter. Compared with the conventional wet preparation method which needs addition of a binder and adopts spray drying, the preparation method of the present disclosure does not need any binder added into the micronutrient, thus has reduced production cost. Moreover, when granulating according to the preparation method of the present disclosure, it is not necessary to form slurry which is necessary in the conventional method by stirring and dissolving the micronutrients and the binder. Therefore, drying is unnecessary in the present method. Thus, the method greatly improves the production efficiency. Furthermore, since no binder is added in the micronutrient, the product prepared with the method of the present disclosure has a higher purity.

(2) The apparatus of the present disclosure adopts two screening machines to perform the screening step. The screen(s) of the primary screening machine is square-mesh screen(s), and the screen of the secondary screening machine is round-mesh screen. Using screen(s) with the certain square-mesh size(s) and the screen with the certain round-mesh diameter, the screening effect is better, screening fractions are more complete, the micronutrient granules with a predetermined granule diameter can be obtained, and the one-time granulation rate is more than 80%.

(3) The apparatus of the present disclosure adopts the pressing vacuum feeder and the screening vacuum feeder to feed, thereby reducing the dust generating in the production processes, and mitigating the influence of the micronutrient dust on the health of workers.

(4) In the apparatus of the present disclosure, the coarse-granule outlet of the primary screening machine is connected with the second grinding and granulating machine, and after being grinded again, the coarse granules obtained from the primary screening stage are fed back to the primary screening machine to be screened again. The fine powder outlets of the primary and the secondary screening machines are connected to the pressing vacuum feeder, and the fine powder obtained by screening is fed back to the tablet press to be pressed to agglomerate again, thereby realizing the internal circulation of the materials, and reducing the waste of the materials.

### BRIEF DESCRIPTION OF DRAWINGS

FIG. 1 is a structure diagram of the apparatus of the present disclosure.

FIG. 2 is a process flowchart of the preparation method of the present disclosure.

The reference signs respectively indicate:
1. a tablet press; 2. a first grinding and granulating machine; 3. a primary screening machine; 4. a secondary screening machine; 5. a pressing vacuum feeder; 6. a feeding bucket; 7. a screening vacuum feeder; 8. a screening bin; 9. a second grinding and granulating machine; 10. a fine powder buffer bucket; 101. a pressing feed bin; 102. a pressing feeding screw; and 103. a pressing roller.

### DETAILED DESCRIPTION

For better understanding of the present disclosure in combination with the accompanying drawings and preferred embodiments, the present disclosure is described below more comprehensively and in more detail. However, the protection scopes of the present disclosure are not limited to the following specific embodiments.

It is to be noted that when a certain component is described as “being fixed to, fixedly connected to, connected to or intercommunicated with” another component, it may be directly fixed to, fixedly connected to, connected to or intercommunicated with said another component; or it may be indirectly fixed to, fixedly connected to, connected to or intercommunicated with said another component through an intermediate connector.

Unless otherwise defined, all technical terms used below have the same meaning as that generally understood by those skilled in the art. The technical terms used in the context are only for the purpose of describing the specific embodiments, but do not intend to limit the protection scopes of the present disclosure.

Unless otherwise specified, all materials, reagents, instruments and devices used in the present disclosure may be available in the market or prepared through existing methods.

### Embodiment 1

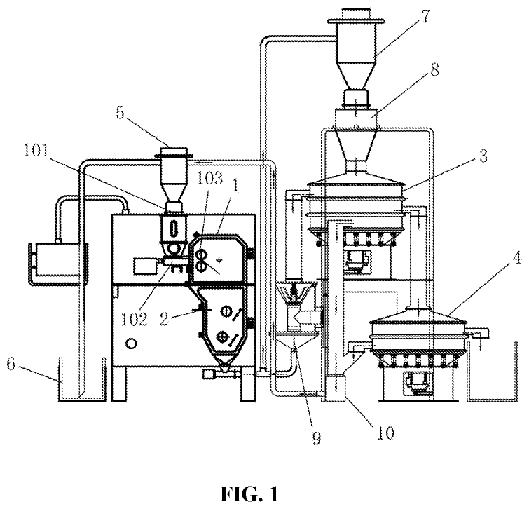

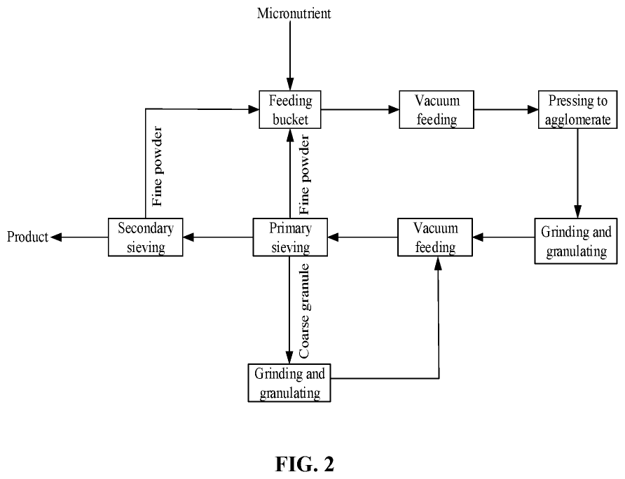

This is an embodiment of the method and apparatus for preparation of micronutrient supplement granules of a basic salt according to the present disclosure. The structure of the preparation apparatus for the micronutrient supplement granules of a basic salt is illustrated in FIG. 1, and the process flow of the preparation method is illustrated in FIG. 2. It can be seen from FIG. 1 that the preparation apparatus includes the tablet press 1, the first grinding and granulating machine 2 and the screening unit. The discharge end of the tablet press 1 is connected with the feed end of the first grinding and granulating machine 2. The discharge end of the first grinding and granulating machine 2 is connected to the feed end of the screening unit. The screening unit includes the primary screening machine 3 and the secondary screening machine 4. The feed end of the primary screening machine 3 is connected to the discharge end of the first grinding and granulating machine 2. The discharge end of the primary screening machine 3 is connected to the feed end of the secondary screening machine 4. The screen of the primary screening machine 3 is a square-mesh screen, and the screen of the secondary screening machine 4 is a round-mesh screen. The square-mesh of the screen of the primary screening machine 3 has a size preferably ranging from 8 mm×8 mm to 3 mm×3 mm, and the round-mesh of the screen of the secondary screening machine 4 has a diameter preferably ranging from 0.8 mm to 2.1 mm, in which the primary screening machine has two screens, in which the upper screen has the larger square-mesh size of 8 mm×8 mm and the lower screen has the smaller square-mesh size of 3 mm×3 mm. The granules between the two screens are kept. Accordingly, with the two-stage screening, the screening is more complete, and the micronutrient supplement granules of the basic salt with a granule diameter of 35 μm to 380 μm are obtained. More preferably, the square-mesh sizes of the screens of the primary screening machine 3 are ranging from 5 mm×5 mm to 4 mm×4 mm, and the round-mesh diameter of the screen of the secondary screening machine is ranging from 1.0 mm to 1.5 mm. This preparation apparatus can be used to treat a variety of basic salts including basic zinc chloride, basic zinc sulfate, basic cupric chloride, basic cupric sulfate, manganese hydroxy chloride and basic manganese sulfate, or mixtures thereof.

In the present embodiment, the tablet press 1 has a pressing feed bin 101. The lower part of the pressing feed bin 101 is connected to the feed end of a pressing feeding screw 102. The discharge end of the pressing feeding screw 102 is connected to a pressing roller 103. The conveying speed of the pressing feeding screw 102 is preferably from 20 r/min to 200 r/min, and the pressure applied by the pressing roller 103 is preferably from 1 MPa to 25 MPa. With the conveying speed of pressing feeding screw and the pressure applied by the pressing roller, the micronutrient supplement granules with the strength of over 10 N are obtained. More preferably, the conveying speed of the feeding screw 102 is from 30 r/min to 60 r/min, and the pressure applied by the roller 103 is from 4 MPa to 20 MPa.

In the present embodiment, the feed end of the tablet press 1 is connected to a pressing feeding device. The pressing feeding device includes a pressing vacuum feeder 5, which is connected to a feeding bucket 6 through a pipeline. The screening vacuum feeder 7 and the screening bin 8 are installed between the first grinding and granulating machine 2 and the screening unit. The feed end of the screening vacuum feeder 7 is connected with the discharge end of the first grinding and granulating machine 2 through a pipeline. The discharge end of the screening vacuum feeder 7 is connected to the feed end of the screening bin 8, and the discharge end of the screening bin 8 is connected with the feed end of the primary screening machine 3. In both processes of the pressing feeding and screening feeding, the materials are fed by the vacuum feeders, which reduce the production of basic salt dust, and reduce the influence on the health of workers.

The coarse-granule outlet of the primary screening machine 3 in the preparation apparatus is connected with the feed end of a second grinding and granulating machine 9. The discharge end of the second grinding and granulating machine 9 is connected to the feed end of the screening vacuum feeder 7 through a pipeline. The fine-powder outlet of the primary screening machine 3 and the fine-powder outlet of the secondary screening machine 4 are both connected to the fine powder buffer bucket 10. The fine powder buffer bucket 10 is connected to the feed end of the pressing vacuum feeder 5 through a pipeline. In this way, waste of materials is reduced, and internal circulation of materials is realized. The primary screening machine 3 and the secondary screening machine 4 are flexibly connected through a cloth bag. The screening bin 8 and the primary screening machine 3 are flexibly connected through a cloth bag. The primary screening machine 3 and the second grinding and granulating machine 9 are flexibly connected through a cloth bag. The fine powder outlets of the primary screening machine 3 and the secondary screening machine 4 are also flexibly connected with the fine powder buffer bucket 10 through a cloth bag.

The preparation method of the present disclosure mainly included the following steps. Powder of basic salt(s) in the feeding bucket 6 was pumped into the tablet press 1 by the pressing vacuum feeder 5 to be pressed to agglomerate, and the block or bulk materials were obtained. The block or bulk materials were fed into the first grinding and granulating machine 2 to be grinded. The grinded materials were fed into the primary screening machine 3 by the screening vacuum feeder 7 to be screened. The granules with a desired size obtained from the primary screening machine 3 were fed into the secondary screening machine 4 to be screened again to provide the micronutrient supplement granules of the basic salt(s). The granule size of the micronutrient supplement granules of the basic salt(s) was from 35 μm to 380 μm, and the granule strength was greater than 10 N. The coarse granules obtained from the primary screening machine 3 were fed into the second grinding and granulating machine 9 to be further grinded, and then fed into the primary screening machine 3 by the screening vacuum feeder 7 to be screened. The fine powder obtained from the primary screening machine 3 and the secondary screening machine 4 were fed into the tablet press 1 by the tableting vacuum feeder 5 to be pressed to agglomerate again.

### Embodiment 2

This is an embodiment of the method and apparatus for preparation of micronutrient supplement granules of a hydroxy-methionine chelate according to the present disclosure. The structure of the preparation apparatus for the micronutrient supplement granules of a hydroxy-methionine chelate is illustrated in FIG. 1, and the process flow of the preparation method is illustrated in FIG. 2. It can be seen from FIG. 1 that the preparation apparatus includes the tablet press 1, the first grinding and granulating machine 2 and the screening unit. The discharge end of the tablet press 1 is connected with the feed end of the first grinding and granulating machine 2. The discharge end of the first grinding and granulating machine 2 is connected to the feed end of the screening unit. The screening unit includes the primary screening machine 3 and the secondary screening machine 4. The feed end of the primary screening machine 3 is connected to the discharge end of the first grinding and granulating machine 2. The discharge end of the primary screening machine 3 is connected to the feed end of the secondary screening machine 4. The screen of the primary screening machine 3 is a square-mesh screen, and the screen of the secondary screening machine 4 is a round-mesh screen. The square-mesh of the screen of the primary screening machine 3 has a size preferably ranging from 8 mm×8 mm to 3 mm×3 mm, and the round-mesh of the screen of the secondary screening machine 4 has a diameter preferably ranging from 0.8 mm to 2.1 mm, in which, the primary screening machine has two screens, in which the upper screen has the larger square-mesh size of 8 mm×8 mm and the lower screen has the smaller square-mesh size of 3 mm×3 mm. The granules between the two screens are kept. Accordingly, with the two-stage screening, the screening is more complete, and the micronutrient supplement granules of the hydroxy-methionine chelate with a granule diameter of 35 μm to 380 μm are obtained. More preferably, the square-mesh sizes of the screens of the primary screening machine 3 are ranging from 5 mm×5 mm to 4 mm×4 mm, and the round-mesh diameter of the screen of the secondary screening machine is ranging from 1.0 mm to 1.5 mm.

In the present embodiment, the tablet press 1 has a pressing feed bin 101. The lower part of the pressing feed bin 101 is connected to the feed end of a pressing feeding screw 102. The discharge end of the pressing feeding screw 102 is connected to a pressing roller 103. The conveying speed of the pressing feeding screw 102 is preferably from 20 r/min to 200 r/min, and the pressure applied by the pressing roller 103 is preferably from 1 MPa to 25 MPa. With the conveying speed of pressing feeding screw and the pressure applied by the pressing roller, the micronutrient supplement granules with the strength of over 10 N are obtained. More preferably, the conveying speed of the feeding screw 102 is from 30 r/min to 60 r/min, and the pressure applied by the roller 103 is from 4 MPa to 20 MPa.

In the present embodiment, the feed end of the tablet press 1 is connected to a pressing feeding device. The pressing feeding device includes a pressing vacuum feeder 5, which is connected to a feeding bucket 6 through a pipeline. The screening vacuum feeder 7 and the screening bin 8 are installed between the first grinding and granulating machine 2 and the screening unit. The feed end of the screening vacuum feeder 7 is connected with the discharge end of the first grinding and granulating machine 2 through a pipeline. The discharge end of the screening vacuum feeder 7 is connected to the feed end of the screening bin 8, and the discharge end of the screening bin 8 is connected with the feed end of the primary screening machine 3. In both processes of the pressing feeding and screening feeding, the materials are fed by the vacuum feeders, which reduce the production of hydroxy-methionine chelate dust, and reduce the influence on the health of workers.

The coarse-granule outlet of the primary screening machine 3 in the preparation apparatus is connected with the feed end of a second grinding and granulating machine 9. The discharge end of the second grinding and granulating machine 9 is connected to the feed end of the screening vacuum feeder 7 through a pipeline. The fine-powder outlet of the primary screening machine 3 and the fine-powder outlet of the secondary screening machine 4 are both connected to the fine powder buffer bucket 10. The fine powder buffer bucket 10 is connected to the feed end of the pressing vacuum feeder 5 through a pipeline. In this way, waste of materials is reduced, and internal circulation of materials is realized. The primary screening machine 3 and the secondary screening machine 4 are flexibly connected through a cloth bag. The screening bin 8 and the primary screening machine 3 are flexibly connected through a cloth bag. The primary screening machine 3 and the second grinding and granulating machine 9 are flexibly connected through a cloth bag. The fine powder outlets of the primary screening machine 3 and the secondary screening machine 4 are also flexibly connected with the fine powder buffer bucket 10 through a cloth bag.

The preparation method of the present disclosure mainly included the following steps. Powder of hydroxy-methionine chelate(s) in the feeding bucket 6 was pumped into the tablet press 1 by the pressing vacuum feeder 5 to be pressed to agglomerate, and the block or bulk materials were obtained. The hydroxy-methionine chelate included one or more hydroxy-methionine chelates including hydroxy methionine copper, hydroxy methionine ferrous, hydroxy methionine zinc, and hydroxy methionine manganese, in which the mole ratio of the hydroxy-methionine to the metal ion in the hydroxymethionine chelate was 1:1 or 2:1, preferably 2:1. The block or bulk materials were fed into the first grinding and granulating machine 2 to be grinded. The grinded materials were fed into the primary screening machine 3 by the screening vacuum feeder 7 to be screened. The granules with a desired size obtained from the primary screening machine 3 were fed into the secondary screening machine 4 to be screened again to provide the micronutrient supplement granules of the hydroxy-methionine chelate(s). The granule size of the micronutrient supplement granules of the hydroxy-methionine chelate(s) was from 35 μm to 380 μm, and the granule strength was greater than 10 N. The coarse granules obtained from the primary screening machine 3 were fed into the second grinding and granulating machine 9 to be further grinded, and then fed into the primary screening machine 3 by the screening vacuum feeder 7 to be screened. The fine powder obtained from the primary screening machine 3 and the secondary screening machine 4 were fed into the tablet press 1 by the tableting vacuum feeder 5 to be pressed to agglomerate again.

The above is the preferred embodiments of the present disclosure and not intended to limit the present disclosure. For those skilled in the art, the present disclosure may have various modifications and changes. Any modifications, equivalent replacements, improvements and the like within the spirit and principle of the present disclosure are within the protection scopes claimed by the present disclosure.

### Embodiment 3

This is an embodiment of the method and apparatus for preparation of micronutrient supplement granules of a threonine chelate according to the present disclosure. The structure of the preparation apparatus for the micronutrient supplement granules of a threonine chelate is illustrated in FIG. 1, and the process flow of the preparation method is illustrated in FIG. 2. It can be seen from FIG. 1 that the preparation apparatus includes the tablet press 1, the first grinding and granulating machine 2 and the screening unit. The discharge end of the tablet press 1 is connected with the feed end of the first grinding and granulating machine 2. The discharge end of the first grinding and granulating machine 2 is connected to the feed end of the screening unit. The screening unit includes the primary screening machine 3 and the secondary screening machine 4. The feed end of the primary screening machine 3 is connected to the discharge end of the first grinding and granulating machine 2. The discharge end of the primary screening machine 3 is connected to the feed end of the secondary screening machine 4. The screen of the primary screening machine 3 is a square-mesh screen, and the screen of the secondary screening machine 4 is a round-mesh screen. The square-mesh of the screen of the primary screening machine 3 has a size preferably ranging from 8 mm×8 mm to 3 mm×3 mm, and the round-mesh of the screen of the secondary screening machine 4 has a diameter preferably ranging from 0.8 mm to 2.1 mm, in which, the primary screening machine has two screens, in which the upper screen has the larger square-mesh size of 8 mm×8 mm and the lower screen has the smaller square-mesh size of 3 mm×3 mm. The granules between the two screens are kept. Accordingly, with the two-stage screening, the screening is more complete, and the micronutrient supplement granules of the threonine chelate with a granule diameter of 35 μm to 380 μm are obtained. More preferably, the square-mesh sizes of the screens of the primary screening machine 3 are ranging from 5 mm×5 mm to 4 mm×4 mm, and the round-mesh diameter of the screen of the secondary screening machine is ranging from 1.0 mm to 1.5 mm.

In the present embodiment, the tablet press 1 has a pressing feed bin 101. The lower part of the pressing feed bin 101 is connected to the feed end of a pressing feeding screw 102. The discharge end of the pressing feeding screw 102 is connected to a pressing roller 103. The conveying speed of the pressing feeding screw 102 is preferably from 20 r/min to 200 r/min, and the pressure applied by the pressing roller 103 is preferably from 1 MPa to 25 MPa. With the conveying speed of pressing feeding screw and the pressure applied by the pressing roller, the micronutrient supplement granules with the strength of over 10 N are obtained. More preferably, the conveying speed of the feeding screw 102 is from 30 r/min to 60 r/min, and the pressure applied by the roller 103 is from 4 MPa to 20 MPa.

In the present embodiment, the feed end of the tablet press 1 is connected to a pressing feeding device. The pressing feeding device includes a pressing vacuum feeder 5, which is connected to a feeding bucket 6 through a pipeline. The screening vacuum feeder 7 and the screening bin 8 are installed between the first grinding and granulating machine 2 and the screening unit. The feed end of the screening vacuum feeder 7 is connected with the discharge end of the first grinding and granulating machine 2 through a pipeline. The discharge end of the screening vacuum feeder 7 is connected to the feed end of the screening bin 8, and the discharge end of the screening bin 8 is connected with the feed end of the primary screening machine 3. In both processes of the pressing feeding and screening feeding, the materials are fed by the vacuum feeders, which reduce the production of threonine chelate dust, and reduce the influence on the health of workers.

The coarse-granule outlet of the primary screening machine 3 in the preparation apparatus is connected with the feed end of a second grinding and granulating machine 9. The discharge end of the second grinding and granulating machine 9 is connected to the feed end of the screening vacuum feeder 7 through a pipeline. The fine-powder outlet of the primary screening machine 3 and the fine-powder outlet of the secondary screening machine 4 are both connected to the fine powder buffer bucket 10. The fine powder buffer bucket 10 is connected to the feed end of the pressing vacuum feeder 5 through a pipeline. In this way, waste of materials is reduced, and internal circulation of materials is realized. The primary screening machine 3 and the secondary screening machine 4 are flexibly connected through a cloth bag. The screening bin 8 and the primary screening machine 3 are flexibly connected through a cloth bag. The primary screening machine 3 and the second grinding and granulating machine 9 are flexibly connected through a cloth bag. The fine powder outlets of the primary screening machine 3 and the secondary screening machine 4 are also flexibly connected with the fine powder buffer bucket 10 through a cloth bag.

The preparation method of the present disclosure mainly included the following steps. Powder of threonine chelate(s) in the feeding bucket 6 was pumped into the tablet press 1 by the pressing vacuum feeder 5 to be pressed to agglomerate, and the block or bulk materials were obtained. The threonine chelate included one or more threonine chelates including threonine copper, ferrous threonine, threonine zinc and threonine manganese, in which the mole ratio between the threonine and the metal ion in the hydroxymethionine chelate was 1:1 or 2:1, preferably 2:1. The block or bulk materials were fed into the first grinding and granulating machine 2 to be grinded. The grinded materials were fed into the primary screening machine 3 by the screening vacuum feeder 7 to be screened. The granules with a desired size obtained from the primary screening machine 3 were fed into the secondary screening machine 4 to be screened again to provide the micronutrient supplement granules of the threonine chelate(s). The granule size of the micronutrient supplement granules of the threonine chelate(s) was from 35 μm to 380 μm, and the granule strength was greater than 10 N. The coarse granules obtained from the primary screening machine 3 were fed into the second grinding and granulating machine 9 to be further grinded, and then fed into the primary screening machine 3 by the screening vacuum feeder 7 to be screened. The fine powder obtained from the primary screening machine 3 and the secondary screening machine 4 were fed into the tablet press 1 by the tableting vacuum feeder 5 to be pressed to agglomerate again.

The above is the preferred embodiments of the present disclosure and not intended to limit the present disclosure. For those skilled in the art, the present disclosure may have various modifications and changes. Any modifications, equivalent replacements, improvements and the like within the spirit and principle of the present disclosure are within the protection scopes claimed by the present disclosure.

1. A method for manufacturing micronutrient supplement granules, the method comprising: physically pressing, grinding and sieving a micronutrient in sequence to obtain the micronutrient supplement granules having a particle size of 35 μm to 380 μm and granule strength greater than 10 N.

2. The method of claim 1, wherein the micronutrient comprises a basic salt, a hydroxy-methionine chelate or a threonine chelate;
wherein the basic salt comprises one or more of basic zinc chloride, basic zinc sulfate, basic cupric chloride, basic cupric sulfate, copper(II) carbonate hydroxide, manganese hydroxy chloride, or basic manganese sulfate;
the hydroxy-methionine chelate comprises one or more of hydroxy methionine copper, hydroxy methionine ferrous, hydroxy methionine zinc, or hydroxy methionine manganese, and has a mole ratio of hydroxy-methionine to a metal ion of 1:1 or 2:1; and
the threonine chelate comprises one or more of copper threoninate, ferrous threoninate, zinc threoninate, or manganese threoninate, and has a mole ratio of threonine to a metal ion of 1:1 or 2:1.

3. The method of claim 1, wherein an pressure during the pressing is controlled ranging from 1 MPa to 25 MPa, and a conveying speed of a pressing feeding screw is controlled ranging from 20 r/min to 200 r/min; and wherein the sieving comprises two stages; a sieving mesh used in a primary sieving stage has square mesh holes having a square-mesh size ranging from 8 mm×8 mm to 3 mm×3 mm; and a sieving mesh used in a secondary sieving stage has circular mesh holes having a round mesh diameter ranging from 0.8 mm to 2.1 mm.

4. An apparatus for manufacturing micronutrient supplement granules, comprising: a tablet press, a first grinding and granulating machine, and a sieving unit; wherein a discharge end of the tablet press is connected to a feed end of the first grinding and granulating machine; a discharge end of the first grinding and granulating machine is connected to a feed end of the sieving unit; wherein the sieving unit comprises a primary sieving machine and a secondary sieving machine; a feed end of the primary sieving machine is connected to the discharge end of the first grinding and granulating machine, and a discharge end of the primary sieving machine is connected to a feed end of the secondary sieving machine (4).

5. The apparatus of claim 4, wherein a sieving mesh of the primary sieving machine has square mesh holes, and a sieving mesh of the secondary sieving machine has circular mesh holes; and wherein the sieving mesh of the primary sieving machine has a square-mesh size ranging from 8 mm×8 mm to 3 mm×3 mm, and the sieving mesh of the secondary sieving machine has a round-mesh diameter ranging from 0.8 mm to 2.1 mm.

6. The apparatus of claim 4, wherein the tablet press comprises a pressing feed bin; a lower part of the pressing feed bin is connected to a feed end of a pressing feeding screw; a discharge end of the pressing feeding screw is connected to a pressing roller; a conveying speed of the pressing feeding screw is ranging from 20 r/min to 200 r/min; a pressure applied by the pressing roller is ranging from 1 MPa to 25 MPa.

7. The apparatus of claim 4, wherein a feed end of the tablet press is connected to a pressing feeding device; the pressing feeding device comprises a pressing vacuum feeder, which is connected to a feeding bucket through a pipeline.

8. The apparatus of claim 4, wherein a sieving vacuum feeder and a sieving bin are provided between the first grinding and granulating machine and the sieving unit; a feed end of the sieving vacuum feeder is connected to the discharge end of the first grinding and granulating machine through a pipeline; a discharge end of the sieving vacuum feeder is connected to a feed end of the sieving bin, and a discharge end of the sieving bin is connected to the feed end of the primary sieving machine.

9. The apparatus of claim 8, wherein a coarse-granule outlet of the primary sieving machine is connected to a feed end of a second grinding and granulating machine, and a discharge end of the second grinding and granulating machine is connected to the feed end of the sieving vacuum feeder through a pipeline; and wherein fine powder outlets of the primary sieving machine and the secondary sieving machine are both connected to a fine powder buffer hopper; the fine powder buffer hopper is connected to a feed end of the pressing vacuum feeder through a pipeline.

10. The apparatus of claim 9, wherein the primary sieving machine and the secondary sieving machine are flexibly connected through a cloth bag; the sieving bin and the primary sieving machine are flexibly connected through a cloth bag; the primary sieving machine and the second grinding and granulating machine are flexibly connected through a cloth bag; and the fine powder buffer hopper and the fine powder outlets of the primary sieving machine and the secondary sieving machine are flexibly connected through a cloth bag.

11. Micronutrient supplement granules having a particle size of 35 μm to 380 μm and a particle strength greater than 10 N.

12. The micronutrient supplement granules of claim 11, wherein a micronutrient in the micronutrient supplement granule comprises a basic salt, a hydroxy-methionine chelates, or a threonine chelates.

13. The micronutrient supplement granules of claim 12, wherein the basic salt comprises one or more of basic zinc chloride, basic zinc sulfate, basic cupric chloride, basic cupric sulfate, copper(II) carbonate hydroxide, manganese hydroxy chloride and basic manganese sulfate.

14. The micronutrient supplement granules of claim 12, wherein the hydroxy-methionine chelate comprises one or more of hydroxyl methionine copper, hydroxyl methionine ferrous, hydroxyl methionine zinc and hydroxyl methionine manganese; and wherein a mole ratio of hydroxy-methionine to a metal ion in the hydroxy-methionine chelate is 1:1 or 2:1.

15. The micronutrient supplement granule of claim 12, wherein the threonine chelates comprises one or more of copper threoninate, ferrous threoninate, zinc threoninate, and manganese threoninate; a mole ratio of threonine to a metal ion in the threonine chelate is 1:1 or 2:1.
